(19) United States
(12) Patent Application Publication
(10) Pub. No.: US 2023/0282430 A1
(43) Pub. Date: Sep. 7, 2023

(54) SWITCH ASSEMBLY FOR A VEHICLE

(71) Applicant: MINDA INDUSTRIES LIMITED, Distt. Gurgaon (IN)

(72) Inventors: Ravinder MEHLA, Distt. Gurgaon (IN); Nitin Kumar SINGH, Distt. Gurgaon (IN); Rishi GOYAL, Distt. Gurgaon (IN); Amit Kumar RAI, Distt. Gurgaon (IN)

(21) Appl. No.: 18/178,295

(22) Filed: Mar. 3, 2023

(30) Foreign Application Priority Data
Mar. 3, 2022 (IN) 202211011458

(51) Int. Cl. H01H 23/12; H01H 3/02; H01H 1/58; H01H 23/06

(52) U.S. Cl. CPC H01H 23/12; H01H 3/02; H01H 1/58; H01H 23/06; H01H 2221/00

(57) ABSTRACT

A present disclosure relates to a switch assembly for a vehicle. The switch assembly comprises a housing, a carrier assembly, a base assembly, and an actuator. The carrier assembly is positioned at a top end of the housing. A knob has a protrusion extending downwardly through an opening of an intermediate member. A carrier has a first cutout to accommodate the protrusion of the knob and a second cut-out to movably accommodate a first biasing member. The base assembly comprises a base member and a microswitch supported by the base member and connected to terminals placed within the base member. The actuator is defined with a cam profile configured to allow a displaceable member to displace on the cam profile between a first end and a second end of the actuator.

### TECHNICAL FIELD

The present disclosure generally relates to the field of automobiles. Particularly, but not exclusively, the present disclosure relates to a switch assembly for a vehicle that is configured for making electrical connections for functioning of one or more equipment in the vehicle.

### BACKGROUND OF THE DISCLOSURE

The information in this section merely provides background information related to the present disclosure and may not constitute prior art(s) for the present disclosure.

Vehicles, but not limited to, such as two-wheelers or three-wheelers, or four-wheelers are equipped with at least one switch assembly. The switch assembly is configured to make or break electrical connections for controlling the various functions of the vehicle. These functions may be related to controlling the lighting system, providing indication signals to the other vehicles, or ignition of the fuel in an engine, etc. To perform such functions, the switch assembly includes a plurality of switches that are operated by a user as per their requirements.

Typically, the existing switches include a knob that is connected to a plunger. The plunger is biased by a spring and configured to operate one or more microswitches. The one major shortcoming associated with the switches known in the art is that the plunger makes direct physical contact with the microswitch while operating the switch, which makes the operation of the switch rough thereby wear and tear among the components occurs more. This increases electrical failures and reduces the life of the switch. Also, these switches are not suitable for low-ampere electrical connections.

In addition, the existing switches are ineffective to prevent the ingress of foreign particles such as duct, water, and other particulates etc., that affect the life of the switch. This also reduces the overall performance of the vehicle, which is undesirable.

The present disclosure is directed to overcome one or more limitations stated above or any other limitations associated with the prior art.

### SUMMARY OF THE DISCLOSURE

The one or more shortcomings of the prior art are overcome by the system/assembly as claimed, and additional advantages are provided through the provision of the system/assembly/method as claimed in the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a switch assembly for a vehicle is disclosed. The switch assembly comprises a housing, a carrier assembly, a base assembly, and an actuator. The housing has a top end, a bottom end, and an intermediate member positioned between the top end and the bottom end. The intermediate member has an opening at center axis of the housing. The carrier assembly is positioned at the top end of the housing. The carrier assembly comprises a knob having a protrusion extending downwardly through the opening of the intermediate member, and a carrier having a first cutout to accommodate the protrusion of the knob and a second cut-out to movably accommodate a first biasing member. The base assembly is positioned at the bottom end of the housing. The base assembly comprises a base member attached to the housing, and a microswitch supported by the base member and connected to terminals placed within the base member. The actuator is movably supported by the base member. The actuator is defined with a cam profile configured to allow a displaceable member to displace on the cam profile between a first end and a second end of the actuator. The displaceable member is biased by the first biasing member against the cam profile of the actuator and displaced on the cam profile of the actuator based on the movement of the carrier of the carrier assembly.

In an embodiment of the present application, the carrier of the carrier assembly is moved angularly by operating the knob.

In an embodiment of the present application, the displacement of the displaceable member between the first end and the second end of the actuator actuates the actuator for switching from ‘OFF’ condition to ‘ON’ condition and ‘ON’ condition to ‘OFF’ condition.

In an embodiment of the present application, the actuator operates the microswitch to make an electrical connection for ‘ON’ condition when the displaceable member is positioned at the first end of the actuator.

In an embodiment of the present application, the first end of the actuator stays away from the microswitch for ‘OFF’ condition when the displaceable member is positioned at the second end of the actuator.

In an embodiment of the present application, the microswitch is operated to selectively make the electrical connection within the terminals.

In an embodiment of the present application, the actuator is pivotally supported by the base member.

In an embodiment of the present application, the intermediate member is defined with a raised portion positioned at the center axis of the housing to support the knob.

In an embodiment of the present application, the raised portion along with the opening of the intermediate portion encircles the carrier to limit the movement of the carrier.

In an embodiment of the present application, the switch assembly comprises a sealing member placed between the carrier and the intermediate member, wherein the sealing member is a o-ring having diameter greater than diameter of the opening of the intermediate member.

In an embodiment of the present application, the carrier assembly comprises a plunger, wherein the plunger is positioned within the second cutout of the carrier, wherein a lower end of the plunger is defined with a shape corresponding to a shape of the displaceable member to prevent movement of the displaceable member out from ends of the actuator.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates a perspective view of a switch assembly for a vehicle, in accordance with an embodiment of the present disclosure;

FIG. 2 illustrates a front view of the switch assembly for the vehicle, in accordance with an embodiment of the present disclosure;

FIG. 3 illustrates an exploded view of the switch assembly for the vehicle, in accordance with an embodiment of the present disclosure;

FIG. 4 illustrates a cut-sectional view of the switch assembly in ‘OFF’ condition, in accordance with an embodiment of the present disclosure; and

FIG. 5 illustrates a cut-sectional view of the switch assembly in ‘ON’ condition, in accordance with an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help improve understanding of embodiments of the present disclosure.

### DETAILED DESCRIPTION

While the disclosure is susceptible to various modifications and alternative forms, specific embodiments thereof have been shown by way of example in the Figures and are described in detail below. However, it should be understood that it is not intended to limit the disclosure to the particular forms disclosed. on the contrary, the disclosure is to cover all modifications, equivalents, and alternatives falling within the scope of the disclosure as defined by the appended claims.

Before describing detailed embodiments, it may be observed that the novelty and inventive step that are in accordance with the present disclosure reside in a switch assembly for a vehicle. It is to be noted that a person skilled in the art can be motivated by the present disclosure and modify the various constructions of the switch assembly. However, such modification should be construed within the scope of the present disclosure. Accordingly, the drawings show only those specific details that are pertinent to understanding the embodiments of the present disclosure so as not to obscure the disclosure with details that will be readily apparent to those of ordinary skill in the art having the benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover non-exclusive inclusions, such that a device that comprises a list of components does not include only those components but may include other components not expressly listed or inherent to such setup or device. In other words, one or more elements in a system or apparatus proceeded by “comprises . . . ” does not, without more constraints, preclude the existence of other elements or additional elements in the system or apparatus.

The terms like “at least one” and “one or more” may be used interchangeably or in combination throughout the description.

Embodiments of the present disclosure disclose a switch assembly for a vehicle is disclosed. The switch assembly comprises a housing, a carrier assembly, a base assembly and an actuator. The housing has a top end, a bottom end, and an intermediate member positioned between the top end and the bottom end. The intermediate member has an opening at center axis of the housing. The carrier assembly is positioned at the top end of the housing. The carrier assembly comprises a knob having a protrusion extending downwardly through the opening of the intermediate member, and a carrier having a first cutout to accommodate the protrusion of the knob and a second cut-out to movably accommodate a first biasing member. The base assembly is positioned at the bottom end of the housing. The base assembly comprises a base member attached to the housing, and a microswitch supported by the base member and connected to terminals placed within the base member. The actuator is movably supported by the base member. The actuator is defined with a cam profile configured to allow a displaceable member to displace between a first end and a second end of the actuator. The displaceable member is biased by the first biasing member against the cam profile of the actuator and displaced on the cam profile of the actuator based on movement of the carrier of the carrier assembly. Accordingly, the switch assembly prevents direct physical contact of a switch component connected to the knob with the microswitch for reducing wear and tear among the components of the switch assembly and increases the overall life of the switch assembly. The switch assembly of the present disclosure is simple, economical, and easy to manufacture.

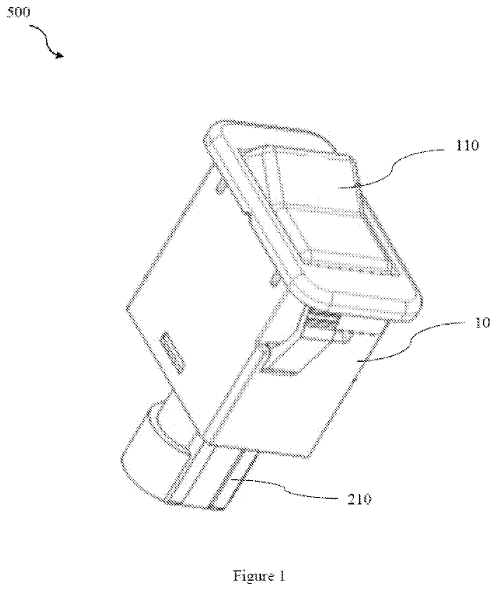

Reference will now be made to the exemplary embodiments of the disclosure, as illustrated in the accompanying drawings. Wherever possible, the same numerals will be used to refer to the same or like parts. Embodiments of the disclosure are described in the following paragraphs with reference to FIGS. 1 to 5. In FIGS. 1 to 5, the same element or elements which have the same functions are indicated by the same reference signs.

Referring to FIG. 1, a switch assembly (500) for a vehicle, according to an embodiment of the present disclosure, is depicted. The switch assembly (500) is configured for making or braking electrical connections for functioning one or more equipment in the vehicle. The switch assembly (500) is configured to be utilized in the two-wheeled vehicle. Alternatively, the switch assembly (500) may be utilized in vehicles other than two-wheeled vehicles, without limiting the scope of the present disclosure. The switch assembly (500) of the present disclosure is configured for low-ampere applications. Alternatively, the switch assembly (500) may be utilized for applications having different current capacities, without limiting the scope of the present disclosure.

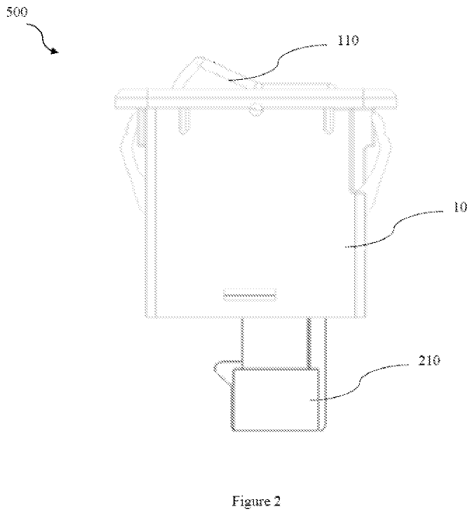

Referring to FIG. 2, the switch assembly (500) comprises a housing (10). The housing (10) is configured to include one or more components of the switch assembly (500). The housing (10) is defined with a top end (20), a bottom end (30), and an intermediate member (40). The top end (20) and the bottom end (30) of the housing (10) are opened to receive other components of the switch assembly (500) in the housing (10). The intermediate member (40) is positioned between the top end (20) and the bottom end (30). The intermediate member (40) may be a part of the housing (10) that extends from one internal wall surface to the other internal wall surfaces of the housing (10).

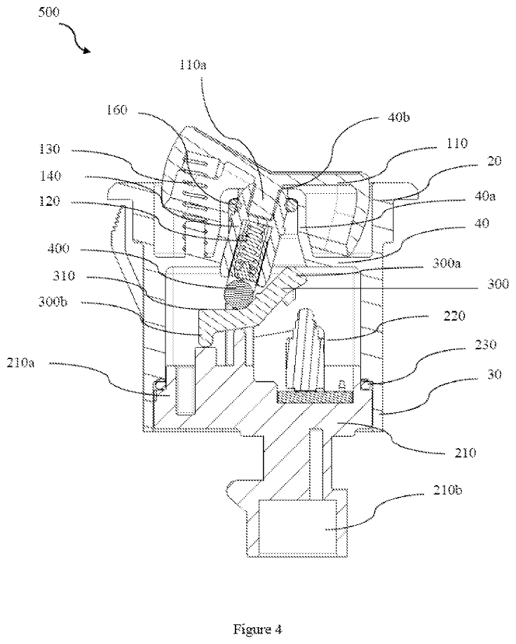

The intermediate member (40) is defined with a raised portion (40a), as shown in FIG. 4. The raised portion (40a) extends towards the top end (20) of the housing (10). The raised portion (40a) may have a hollow portion defined between a flat surface and at least one side wall. The intermediate member (40) has an opening (40b) formed at the flat surface disposed at upper ends of the side walls of the raised portion (40a). The raised portion (40a) and the opening (40b) lies at center axis of the housing (10). In an alternate embodiment, the raised portion (40a) and the opening (40b) may be positioned offset from the center axis of the housing (10), without limiting the scope of the present disclosure.

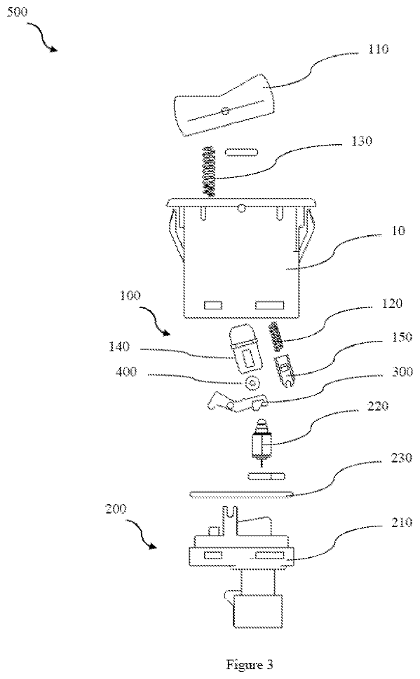

Referring to FIG. 3, the switch assembly (500) comprises a carrier assembly (100). The carrier assembly (100) is positioned at the top end (20) of the housing (10). The carrier assembly (100) comprises a knob (110) that is positioned at the top end (20) of the housing (10) such that a user can operate thereof. The knob (110) is configured to be operated by the user for actuating other components of the switch assembly (500) in order to make or brake the electrical connections. The knob (110) is defined with a protrusion (110a) that extends downwardly through the opening (40b) of the intermediate member (40). The knob (110) has at least one portion that is biased through a second biasing member (130). The second biasing member (130) may be a spring that is extended between the intermediate member (40) and a body of the knob (110). The second biasing member (130) is configured to keep the knob (110) at ‘OFF’ condition.

Referring back to FIG. 3, the carrier assembly (100) comprises a carrier (140) that is positioned within the hollow portion of the raised portion (40a) of the intermediate member (40). The carrier (140) has a first cutout that is formed at an upper end of the carrier (140) to accommodate the protrusion (110a) of the knob (110). The knob (110) may be fixedly connected to the carrier (140). In an embodiment, the carrier (140) has a second cut-out that is formed at a lower end of the carrier assembly (100) to accommodate a first biasing member (120). The first biasing member (120) may be a spring that has one end connected to the carrier (140) and the other end freely positioned outside of the carrier (140). In an alternate embodiment, the carrier assembly (100) comprises a plunger (150) that may be accommodated within the second cutout of the carrier (140). In an alternate embodiment, the first biasing member (120) may be positioned in a cavity defined at the plunger (150), without limiting the scope of the present disclosure. The carrier (140) and the plunger (150) of the carrier assembly (100) are moved angularly by operating the knob (110).

The switch assembly (500) comprises a base assembly (200) that is positioned at the bottom end (30) of the housing (10). The base assembly (200) comprises a base member (210), and a microswitch (220). The base member (210) has an upper end attached to the housing (10) and a lower end extending downwardly outside of the housing (10). The base member (210) may be configured to support other components of the base assembly (200). The microswitch (220) is positioned inside the housing (10) and disposed at the upper end of the base member (210). The microswitch (220) is connected to terminals of the switch assembly (500). The terminals are positioned at the lower end of the base member (210). The terminals are configured to engage or disengage with the one another by the microswitch (220).

The switch assembly (500) comprises an actuator (300). The actuator (300) is a bar-shaped element that is positioned laterally inside the housing (10). The actuator (300) is movably supported by the base member (210). The actuator (300) is pivotally mounted at the upper end of the base member (210). The actuator (300) has a first end (300a) and a second end (300b). A portion of the actuator (300) defined between the first end (300a) and the second end (300b) is supported by the base member (210) such that the first end (300a) and the second end (300b) can displace angularly about the supported portion of the actuator (300).

In an embodiment, the actuator (300) comprises a cam profile (310) that is positioned facing towards the carrier (140) of the carrier assembly (100). The cam profile (310) is configured to allow a displaceable member (400) to displace on the cam profile (310) between the first end (300a) and the second end (300b) of the actuator (300). The displaceable member (400) is biased by the first biasing member (120) against the cam profile (310) of the actuator (300). The displaceable member (400) is displaced on the cam profile (310) of the actuator (300) based on the movement of the carrier (140) of the carrier assembly (100). The actuator (300) is actuated based on the displacement of the displaceable member (400). The first end (300a) is configured to operate the microswitch (220) when the displaceable member (400) is positioned at the first end (300a). The second end (300b) rests at the base member (210) when the displaceable member (400) is at the second end (300b).

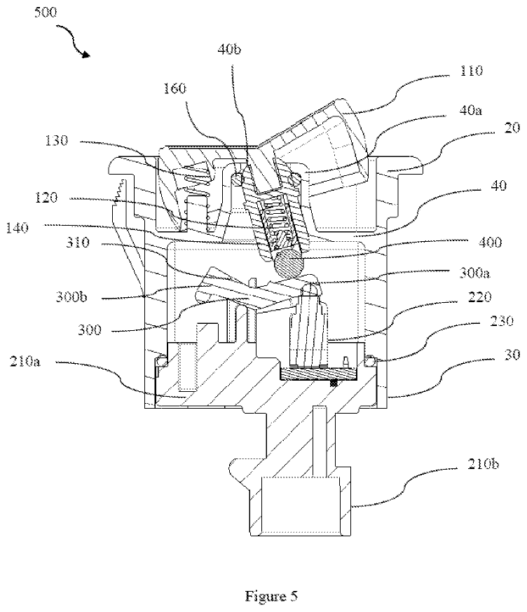

When the user is desired for switching from ‘OFF’ condition to ‘ON’ condition, the user needs to press the knob (110). Upon operating the knob (110), the carrier (140) connected to the protrusion (110a) of the knob (110) is moved angularly in a forward direction, thereby the displaceable member (400) is displaced on the cam profile (310) from the second end (300b) to the first end (300a) of the actuator (300). Subsequently, the first end (300a) of the actuator (300) operates the microswitch (220) that makes an electrical connection for functioning the equipment in the vehicle, as shown in FIG. 5. For switching ‘ON’ condition to ‘OFF’ condition, the user needs to release the knob (110). Upon releasing the knob (110), the carrier (140) is moved angularly in a reverse direction, thereby the displacement member (400) is displaced on the cam profile (310) from the first end (300a) to the second end (300b) of the actuator (300). Subsequently, the first end (300a) of the actuator (300) moves away from the microswitch (220) and the second end (300b) of the actuator (300) rests at the base member (210) in order to brake the electrical connection and stop functioning of the equipment in the vehicle, as shown in FIG. 4.

The displaceable member (400) may have a cylindrical shape, a spherical shape, and any other curved shape, without limiting the scope of the present disclosure. The plunger (150) has a lower end that is defined with a shape corresponding to shape of the displaceable member (400) in order to prevent the displacement of the displaceable member (400) out of the first end (300a) and the second end (300b) of the actuator (300). The raised portion (40a) of the intermediate portion is defined with the side walls that encircle the carrier (140) in order to limit the movement of the carrier (140). The switch assembly (500) comprises a sealing member (160) that is placed between the carrier (140) and the intermediate member (40) in order to prevent ingress of the foreign particles inside the housing (10). The sealing member (160) may be an o-ring. The sealing member (160) has diameter greater than diameter of the opening (40b) of the intermediate member (40). Also, the switch assembly (500) comprises a gasket (230) positioned between the base member (210) and the housing (10) in order to prevent ingress of the foreign particles inside the housing (10).

In accordance with the present disclosure, the switch assembly (500), as explained in the above paragraphs, prevents electrical failure and has a long life. The switch assembly (500) eliminates direct physical contact between the plunger/knob and the microswitch and reduces wear and tear among the parts of the switch assembly. The switch assembly (500) prevents ingress of foreign particles inside the housing. The switch assembly (500) is an integrated connector where no pigtail is required. The switch assembly prevents corrosion/oxidation on electrical contacts. The switch assembly (500) is simple, easy to manufacture, and economical.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. The thicknesses and dimensions of some components may be exaggerated for clarity.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein, the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components but do not preclude the presence or addition of one or more other features, operations, elements, components, and/or groups thereof.

While considerable emphasis has been placed herein on the particular features of this disclosure, it will be appreciated that various modifications can be made and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

LIST OF REFERENCE NUMERALS

| Sr. No. | Description |
|---|---|
| 500 | Switch assembly |
| 10 | Housing |
| 20 | Top end |
| 30 | Bottom end |
| 40 | Intermediate member |
| 40a | Raised portion |
| 40b | Openning |
| 100 | Carrier assembly |
| 110 | Knob |
| 110a | Protrusion |
| 120 | First biasing member |
| 130 | Second biasing member |
| 140 | Carrier |
| 150 | Plunger |
| 160 | Sealing member |
| 200 | Base assembly |
| 210 | Base member |
| 210a | Upper end of the base member |
| 210b | Lower end of the base member |
| 220 | Microswitch |
| 230 | Gasket |
| 300 | Actuator |
| 300a | First end |
| 300b | Second end |
| 310 | Cam profile |
| 400 | Displaceable member |

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles, and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations, and it is envisaged that the values higher/lower than the numerical values assigned to the parameters, dimensions or quantities fall within the scope of the disclosure unless there is a statement in the specification specific to the contrary.

We claim:

1. A switch assembly for a vehicle, the switch assembly comprising:
a housing having a top end, a bottom end, and an intermediate member positioned between the top end, the bottom end, wherein the intermediate member has an opening at center axis of the housing;
a carrier assembly positioned at the top end of the housing, wherein the carrier assembly comprises:
a knob having a protrusion extending downwardly through the opening of the intermediate member; and
a carrier having a first cutout to accommodate the protrusion of the knob and a second cut-out to movably accommodate a first biasing member;
a base assembly positioned at the bottom end of the housing, the base assembly comprises:
a base member attached to the housing;
a microswitch supported by the base member and connected to terminals placed within the base member; and
an actuator, wherein:
the actuator is movably supported by the base member,
the actuator is defined with a cam profile configured to allow a displaceable member to displace on the cam profile between a first end and a second end of the actuator, and
the displaceable member is biased by the first biasing member against the cam profile of the actuator and displaced on the cam profile of the actuator based on movement of the carrier of the carrier assembly.

2. The switch assembly as claimed in claim 1, wherein the carrier of the carrier assembly is moved angularly by operating the knob.

3. The switch assembly as claimed in claim 1, wherein the carrier assembly comprises a plunger positioned within the second cutout of the carrier wherein the plunger has a lower end defined with a shape corresponding to a shape of the displaceable member to prevent movement of the displaceable member out from ends of the actuator.

4. The switch assembly as claimed in claim 1, wherein the displacement of the displaceable member between the first end and the second end of the actuator actuates the actuator for switching from ‘OFF’ condition to ‘ON’ condition and ‘ON’ condition to ‘OFF’ condition.

5. The switch assembly as claimed in claim 1, wherein the actuator operates the microswitch to make an electrical connection for ‘ON’ condition when the displaceable member is positioned at the first end of the actuator.

6. The switch assembly as claimed in claim 1, wherein the first end of the actuator stays away from the microswitch for ‘OFF’ condition when the displaceable member is positioned at the second end of the actuator.

7. The switch assembly as claimed in claim 1, wherein the microswitch is operated to selectively make the electrical connection within the terminals.

8. The switch assembly as claimed in claim 1, wherein the actuator is pivotally supported by the base member.

9. The switch assembly as claimed in claim 1, wherein the intermediate member is defined with a raised portion positioned at the center axis of the housing to support the knob.

10. The switch assembly as claimed in claim 9, wherein the raised portion along with the opening of the intermediate member encircles the carrier to limit the movement of the carrier.

11. The switch assembly as claimed in claim 1, comprising a sealing member placed between the carrier and the intermediate member, wherein the sealing member is a o-ring having diameter greater than diameter of the opening of the intermediate member.
